(19) United States
(12) Patent Application Publication
(10) Pub. No.: US 2026/0065216 A1
(43) Pub. Date: Mar. 5, 2026

(54) Directional Guidance Using Combined Sensor Data

(71) Applicant: ZEBRA TECHNOLOGIES CORPORATION, Lincolnshire, IL (US)

(72) Inventors: Matthew V. Avallone, Dix Hills, NY (US); Nicolas F. Casazzone, Dix Hills, NY (US)

(21) Appl. No.: 18/821,268

(22) Filed: Aug. 30, 2024

(51) Int. Cl. G06Q 10/087; G06F 16/532; G06V 20/60

(52) U.S. Cl. CPC G06Q 10/087; G06F 16/532; G06V 20/60; G06V 2201/07

(57) ABSTRACT

A method in a computing device includes: obtaining an item identifier; capturing, via a camera, an image of a portion of a facility; capturing, via a radio frequency identification (RFID) reader, a tag identifier from an RFID tag associated with an item disposed in the facility; in response to determining that the tag identifier is associated with the item identifier, detecting from the image a visual feature of the item identifier; determining, based on the visual feature, a candidate position of the item and the RFID tag in the image; and controlling an output device to present the candidate position.

### BACKGROUND

In environments such as warehouses, retail facilities, or the like, staff may be assigned tasks such as picking for order fulfillment. A pick task may include traversing the facility to retrieve certain items corresponding to the items identified in an order to be fulfilled. Such facilities may contain many thousands of distinct item types (e.g., tens or hundreds of thousands of distinct stock keeping units, or SKUs), and locating a particular item may therefore be challenging.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a computing device for directional guidance using combined sensor data.

FIG. 2 is a flowchart of a method of directional guidance using combined sensor data.

FIG. 3 is a diagram illustrating an example performance of blocks 205 and 210 of the method of FIG. 2.

FIG. 4 is a diagram illustrating an example performance of blocks 215 and 220 of the method of FIG. 2.

FIG. 5 is a diagram illustrating another example performance of block 225 of the method of FIG. 2.

FIG. 6 is a diagram illustrating an example performance of blocks 230 and 235 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device including: obtaining an item identifier; capturing, via a camera, an image of a portion of a facility; capturing, via a radio frequency identification (RFID) reader, a tag identifier from an RFID tag associated with an item disposed in the facility; in response to determining that the tag identifier is associated with the item identifier, detecting from the image a visual feature of the item identifier; determining, based on the visual feature, a candidate position of the item and the RFID tag in the image; and controlling an output device to present the candidate position.

Additional examples disclosed herein are directed to a computing device, comprising: a camera; a radio frequency identification (RFID) reader; and a processor configured to: obtain an item identifier; capture, via a the camera, an image of a portion of a facility; capture, via a the radio frequency identification (RFID) reader, a tag identifier from an RFID tag associated with an item disposed in the facility in association with an item; in response to determining that the tag identifier is associated with the item identifier, detect from the image a visual feature in the image of the item identifier; determine, based on the visual feature, a candidate position of the item and the RFID tag in the image; and control an output device to present the candidate position.

Further examples disclosed herein are directed to a non-transitory computer-readable medium storing a plurality of instructions executable by a processor of a computing device to: obtain an item identifier; capture, via a camera, an image of a portion of a facility; capture, via a radio frequency identification (RFID) reader, a tag identifier from an RFID tag associated with an item disposed in the facility; in response to determining that the tag identifier is associated with the item identifier, detect from the image a visual feature of the item identifier; determine, based on the visual feature, a candidate position of the item and the RFID tag in the image; and control an output device to present the candidate position.

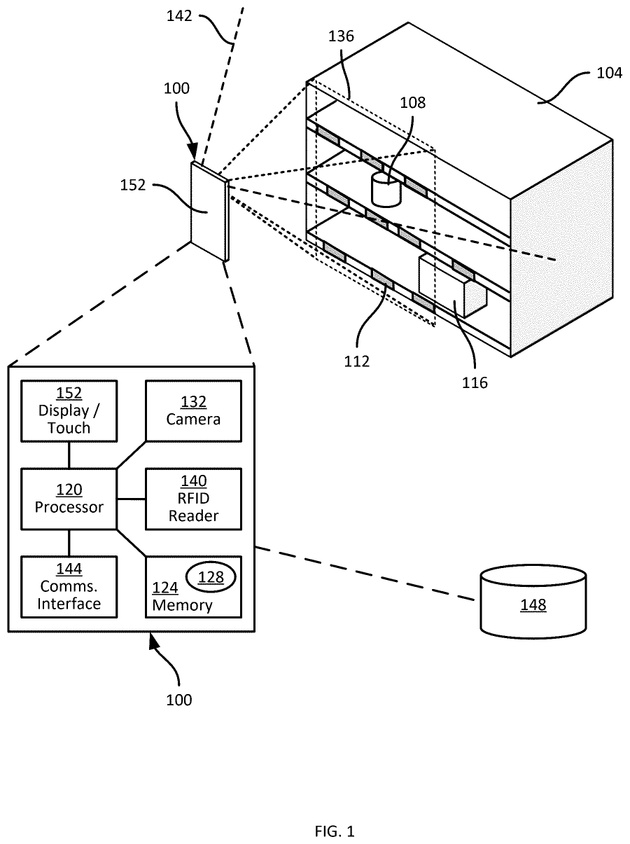

FIG. 1 illustrates a computing device 100, such as a mobile computer, a smart phone, a barcode scanner, a device mounted on a chassis of an autonomous or semi-autonomous apparatus, or the like. The device 100 includes a housing supporting various components of the device 100, discussed below. The device 100 can be implemented in any of a variety of form factors, in addition to the tablet-style form factor shown in FIG. 1. For example, in other embodiments the device 100 can be implemented with a pistol grip, in a wearable (e.g., wrist-mounted) form factor, or the like.

The device 100 can be deployed within a facility such as a warehouse, a retail facility such as a grocer, apparel store, or the like, to assist an operator thereof in locating items in the facility. As will be apparent from the discussion below, the device 100 can also be deployed in a wide variety of other facilities, such as healthcare facilities (e.g., to locate items in a pharmacy), manufacturing facilities, and the like. The operator of the device 100 (or the device 100 itself, in implementations where the device 100 is mounted on an autonomous or semi-autonomous apparatus) can perform tasks such as picking for order fulfillment, in which the operator travels the facilities to locate certain items, according to a list defining the order to be fulfilled.

FIG. 1 illustrates an example support structure 104, such as a shelf module, supporting an example item 108. The support structure can include shelves, e.g., including labels 112 on shelf edges thereof. The labels 112 can include information identifying a specific type of item, e.g., a given Stock Keeping Unit or SKU, of which several instances may be supported on the shelf adjacent to the label. Some labels 112 can also, in some examples, indicate categories of items (e.g., “pasta”), rather than corresponding to a specific SKU. In some cases, items 108 may be stored within a receptacle 116 such as a bin, box, or the like. Items 108 stored in such a receptacle may therefore not be directly visible.

The above-mentioned facilities may contain large numbers of distinct types of items 108 (e.g., thousands, tens of thousands of distinct SKUs, or more). Locating items of a specific type can therefore be challenging, e.g., for an operator of the device 100 engaged in picking items to fulfill an order. As discussed below, the device 100 is configured to combine sensor data from both a camera and a radio frequency identification (RFID) reader to facilitate location of items, e.g., by the operator of the device 100.

In systems employing camera data alone, item location may be complicated by the presence of numerous types of items with various visual similarities (e.g., in size, color, or the like), the storage of the item in a receptacle 116, or the like. Further, although the items 108 and/or the labels 112 may include barcodes encoding item identifiers such as a SKU, a Universal Product Code (UPC) or other form of Global Trade Item Number (GTIN), barcodes may be difficult to decode from an image of the shelf module 104, e.g., because the resolution of the image may be insufficient.

In systems employing RFID data alone, guidance provided to a picker for locating an item may be limited to an indication of whether the item sought was detected (that is, whether one or more tags matching the SKU or other item identifier were captured in an RFID scan). That is, directional guidance indicating a position of the item relative to the device 100 may be unavailable.

By employing RFID and image sensor modalities in combination, as discussed herein, the device 100 can improve the accuracy of directional guidance provided to an operator of the device 100 for use in locating items 108.

Certain internal components of the device 100 are shown in FIG. 1. The device 100 includes a housing supporting various other components of the device 100, including a processor 120, such as a central processing unit (CPU), graphics processing unit (GPU), application-specific integrated circuit (ASIC), or the like. The processor 120 is communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example an item detection application 128, whose execution by the processor 120 configures the device 100 to process data captured via sensors of the device 100 to detect items 108 and provide directional guidance to the items 108.

The sensors of the device 100 include a camera 132, e.g., including a suitable image sensor, a lens assembly, and the like operable to capture an image of a portion of the facility within a field of view (FOV) 136. The sensors of the device 100 further include an RFID reader 140, e.g., including one or more antenna elements, transceivers and the like, configured to emit interrogation signals and capture return signals from RFID tags affixed to the items 108, the shelf module 104, or the like. The RFID reader 140 can be disposed on the device 100 to scan within a field 142 that is substantially centered about the FOV 136 of the camera 132. In other words, the area over which the RFID reader 140 can perform a scan operation can be aimed in substantially the same direction as the FOV 136, although the “view” angle of the RFID reader 140 may be greater than that of the camera 132.

The device 100 can also include a communications interface 144, enabling the device 100 to communicate with other computing devices via any suitable communications links, including wireless and/or wired local-area and/or wide-area networks (e.g., Wi-Fi networks, cellular networks, and the like). The device 100 can, for example, be configured to retrieve data from a repository 148 hosted at a server or other computing device via the communications interface 144.

The device 100 can also include one or more input and output devices, such as a display with an integrated touch screen 152. In other examples, the device 100 can include a keypad, trigger button, or the like, instead of or in addition to the touch screen. The device 100 can also include other output devices in some examples, e.g., a speaker or the like. As shown in FIG. 1, the display and touch screen 152 are disposed on an opposite side of the device 100 from the camera 132 and RFID reader 140, such that the camera 132 and RFID reader 140 are aimed substantially in the direction an operator of the device 100 is facing when the operator views the display 152.

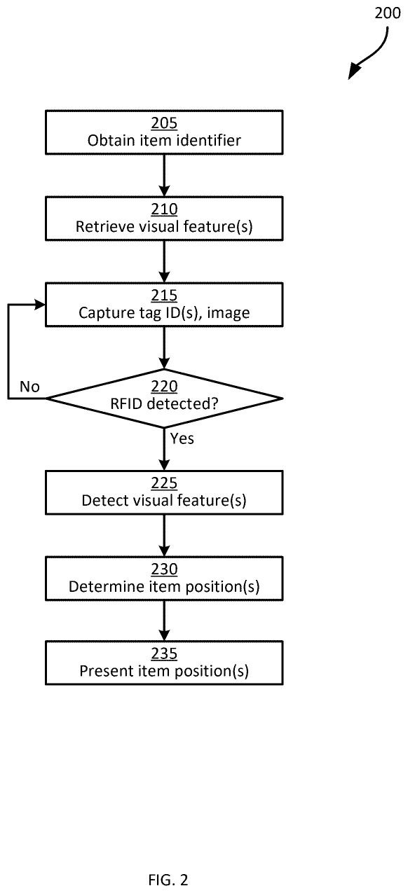

Turning to FIG. 2, a method 200 of directional guidance using combined sensor data is illustrated. The method 200 is described below in conjunction with its performance by the device 100, e.g., via execution of the application 128 by the processor 120, and/or by equivalent dedicated hardware elements such as an ASIC, field-programmable gate array (FPGA) or the like implementing the functionality of the application 128.

At block 205, the device 100 is configured to obtain one or more item identifiers. The item identifier(s) can be included, for example, in a pick list provided to the device 100 by the above-mentioned server hosting the repository 148, or by another computing device configured to receive orders and dispatch the orders for fulfillment. An item identifier obtained at block 205 can include a SKU, a UPC, or other suitable identifier of a type of item. That is, the identifier obtained at block 205 need not include a unique identifier of a specific item 108, such as a tag identifier of an RFID tag affixed to the item 108. For example, a retail facility may contain a plurality of individual items 108 of the same type, all having the same UPC but each having distinct RFID tags affixed thereto. The identifier obtained at block 205 can be a unique identifier encoded in one specific RFID tag, but can also be an identifier of a type of item, such as the above-mentioned UPC.

In other examples, the item identifier obtained at block 205 can be input by an operator of the device 100, e.g., without a pick list. The method 200 can, in other words, be performed to locate arbitrary items 108 as well as to assist in picking for order fulfillment.

At block 210, the device 100 is configured to retrieve one or more visual features corresponding to the item identifier from block 205. The visual feature(s) can be retrieved from the repository 148, for example by querying the repository 148 with the item identifier from block 205. In other examples, one or more of the visual features retrieved at block 210 can be received as input from the operator of the device 100. Any of a variety of visual features can be retrieved at block 210. The visual features are associated with the item 108 corresponding to the item identifier from block 205. The visual features can be features of the item 108 itself, or of a receptacle in which the item 108 is stored. For example, the visual features retrieved at block 210 can include any one or, or any combination of, a shape, color, dimension, or text string appearing on the item 108 itself, a shape, color, dimension, or text string appearing on a receptacle containing the item 108, and/or a shape, color, dimension, or text string of a label, sign or the like on a shelf, an aisle marker, or the like.

The visual features retrieved at block 210 need not be sufficient to uniquely distinguish items 108 of the type identified at block 205 from items 108 of other types. Instead, the visual feature(s) can be employed by the device 100 in combination with RFID scan results to provide directional guidance to the item 108.

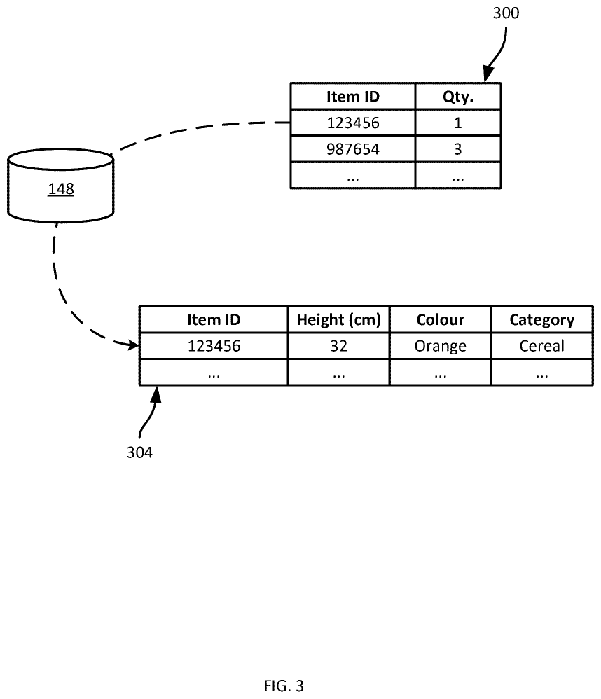

FIG. 3 illustrates an example performance of blocks 205 and 210. For example, the device 108 can receive a pick list 300 including one or more item identifiers, illustrated as six-digit numbers solely for illustrative purposes. It will be understood that any of a wide variety of formats can be employed for item identifiers. The pick list 300 can also include quantities for each item identifier. The device 100 can be configured to select the next un-picked item identifier from the pick list 300 (e.g., the item identifier “123456”) at block 205. The device 100 can retrieve visual features by querying the repository 148 for visual features corresponding to the item identifier “123456”. As shown in FIG. 3, the repository 148 can include, among other information, a set of visual features 304 for at least a portion of the item identifiers. In the illustrated example, the visual features specified in the repository 304 for the item identifier “123456” include a dimension in the form of a height, as well as a color (e.g., a predominant color of the corresponding item 108), and a category (e.g., an indication of a group of item types into which the relevant item identifier falls, an aisle in which the corresponding item is placed, or the like). The visual features can be defined in any of a wide variety of formats, units, and the like, and need not be represented as shown in FIG. 3 in other implementations. For example, the color

At block 215, the device 100 is configured to capture an image via the camera 132, and to perform an RFID scan in order to capture one or more tag identifiers from RFID tags affixed to or otherwise associated with items 108. The RFID scan and the image capture can be performed substantially simultaneously, such that the camera 132 and the RFID reader 140 capture, respectively, an image and one or more tag identifiers associated with items in the same general direction from the device 100. In other examples, the image capture and the RFID scan need not be performed simultaneously, so long as they are performed within a time period sufficiently short to minimize movement of the device 100 (and the resulting change in direction of the fields of view of the camera 132 and RFID reader 140) between the two capture operations. For example, the image capture and RFID scan may be performed up to about one second apart, in some implementations.

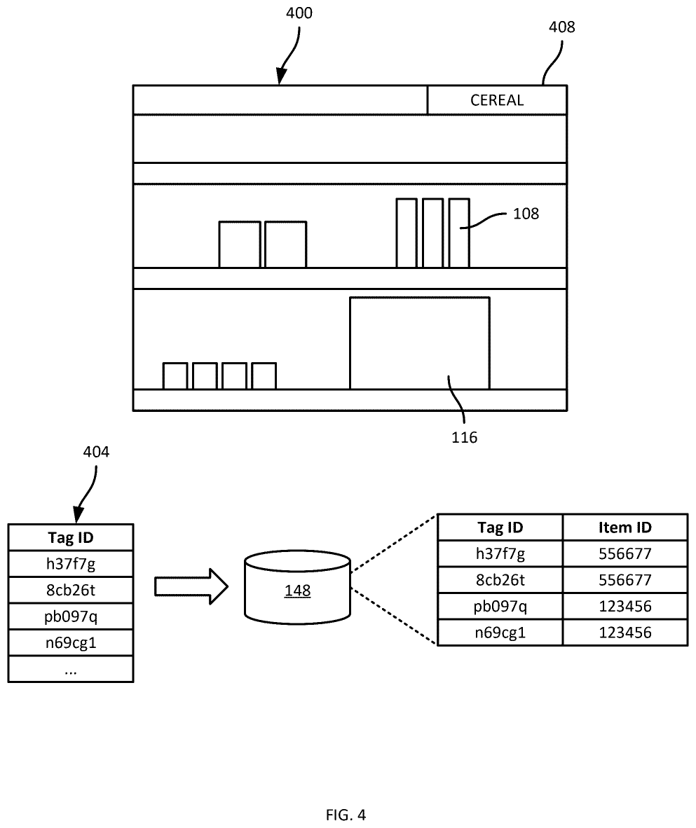

At block 220, the device 100 is configured to determine whether any of the tag identifiers captured at block 215 are associated with the item identifier from block 205. The tag identifiers captured at block 215 can each uniquely identify a given RFID tag, such that multiple instances of the same type of item 108 (e.g., all having the same SKU, UPC, or other item identifier) have different tag identifiers. To make the determination at block 220, the device 100 can be configured to retrieve, either from data received from the interrogated RFID tags, or by querying the repository 148 using the tag identifiers, corresponding item identifiers. For example, turning to FIG. 4, an example image 400 and an example set 404 of tag identifiers captured at block 215 are shown.

The image 400 depicts a portion of the shelves in the facility, as well as items 108 and/or receptacles 116 supported on the shelves. The image 400 also depicts, in this example, a category label 408 disposed on the shelf module, indicating a category of the items 108 in proximity to the label 408. The set 404 can also include other data associated with each tag identifier, such as a received signal strength for each tag, and any other information returned by the tag to the RFID reader 140.

The device 100, in the illustrated example, retrieve from the repository 148 corresponding item identifiers for each tag identifier. As shown in FIG. 4, the repository 148 can contain a list of each tag identifier in the facility, and a corresponding item identifier. The tag identifiers “pb097q” and “n69cg1” in this example both correspond to items 108 with the item identifier “123456”, which matches the item identifier obtained at block 205 in this example performance of the method 200.

When the determination at block 220 is negative (including when no RFID tag identifiers are captured at block 215), the device 100 returns to block 215 to capture another image and perform another RFID scan. The frequency with which block 215 is repeated can be configured, for example according to the use case in which the device 100 is deployed, and/or the computational resources available to the device 100. In the example of pick assistance, the device 100 can be configured to perform block 215 once per five seconds in some examples. More or less frequent repetition of block 215 can also be implemented in other examples, however.

When the determination at block 220 is affirmative, as in the example shown in FIG. 4, in which two tag identifiers in the set 404 correspond to items 108 of the type indicated by the item identifier “123456”, the device 100 proceeds to block 225. At block 225, the device 100 is configured to detect one or more of the visual features retrieved at block 210. In some examples, the retrieval of visual features can be performed in response to the affirmative determination at block 220, rather than prior to the capture of image and RFID data.

To detect the visual features, the device 100 is configured to perform one or more processing operations on the image 400, e.g., the processing operations selected according to the nature of the visual features. For example, the application 128 can implement a mapping between visual feature types and image processing operations.

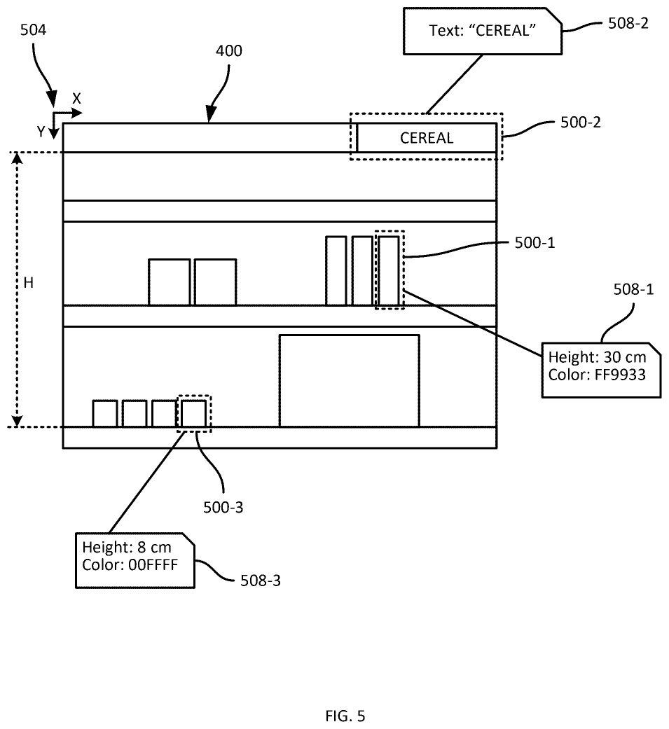

For example, the device 100 can be configured to perform an object detection operation on the image 400 to detect bounding boxes or other boundaries associated with items and other objects in the image 400. Turning to FIG. 5, the image 400 is shown, with a first example bounding box 500-1 and a second example bounding box 500-2. As will be apparent to those skilled in the art, the remaining items 108 in the image 400 can also be identified by further boundaries. Each bounding box 500 can be defined by pixel coordinates, e.g., in a coordinate system 504 of the image 500.

The device 100 can be configured to determine whether each bounding box 500 exhibits any of the visual features retrieved at block 210. For example, the device 100 can store a predefined height “H” for the item-supporting portion of a shelf module, and can estimate a height of a bounding box based on a ratio between the pixel height of that region in the image 400 and the pixel height of the bounding box. As will be apparent, this or other suitable photogrammetric mechanisms can also be employed to estimate dimensions other than height for a detected object. The determined height estimate can then be compared to the height from block 210 (e.g., to determine whether the estimate is within a configurable threshold of the height from block 210). For visual features such as a predominant color, the device 100 can determine a count of pixels within the bounding box that have colors within a certain distance of the specified color of the visual feature (e.g., calculated as a difference between the hexadecimal identifiers of the relevant colors, differences between red, green, and blue values, or the like). The device 100 can then determine whether fraction of the area of the bounding box 500 represented by the above pixel count exceeds a threshold. In other examples, the device 100 can determine whether the specific color is detected at all in the bounding box 500.

Additional processing operations will occur to those skilled in the art to assess the presence or absence of visual features. As a further example, the device 100 can be configured to perform an optical character recognition (OCR) process on a bounding box 500 to extract one or more text strings therefrom. FIG. 5 shows example data 508-1 and 508-2 extracted from the bounding boxes 500-1 and 500-2 respectively. As shown in FIG. 5, the device 100 determines that the bounding box 500-1 has a height of 30 cm, and a predominant (or at least present) color “FF9933” (corresponding to a shade of orange). The device 100 further determines that the bounding box 500-2 contains the text string “cereal”.

FIG. 5 illustrates a further example bounding box 500-3, with data 508-3 representing detected visual features including an estimated height of 8 cm, and a predominant color 00FFFF (corresponding to the color aqua).

Returning to FIG. 2, at block 230, the device 100 is configured to determine one or more candidate positions, within the image 400, for the item identifier from block 205. The candidate position(s) can be determined based on the detected visual features. In particular, the device 100 can determine the candidate position(s) from the bounding boxes 500 having visual attributes that match the visual attributes from block 210. Thus, in the example shown in FIG. 5, the bounding boxes 500-1 and 500-2 may represent candidate positions, while the bounding box 500-3 does not.

When none of the visual attributes from block 210 are detected in the image 400, the device 100 can present (e.g., on the display 152) an indication that although RFID tags have been detected that are associated with the item identifier from block 205, no visual features of that item have been detected. When at least one of the visual attributes is present in a bounding box 500, the position of that bounding box can be used to generate a candidate item position. When more than one adjacent bounding boxes (e.g., within a threshold pixel distance from one another in the image 400) exhibit at least one visual attribute from block 210, a candidate item position can be generated by merging those bounding boxes. At block 235, the device 100 is configured to control an output device, such as the display 152, to present the candidate position(s) generated at block 230.

In the example shown in FIG. 5, the device 100 may therefore generate a candidate position corresponding to the bounding box 500-1, e.g., merging with corresponding bounding boxes for the two items adjacent to the bounding box 500-1. The device 100 does not, however, generate a candidate position corresponding to the bounding box 500-3, as the visual feature data 508-3 does not match any of the visual features from block 210.

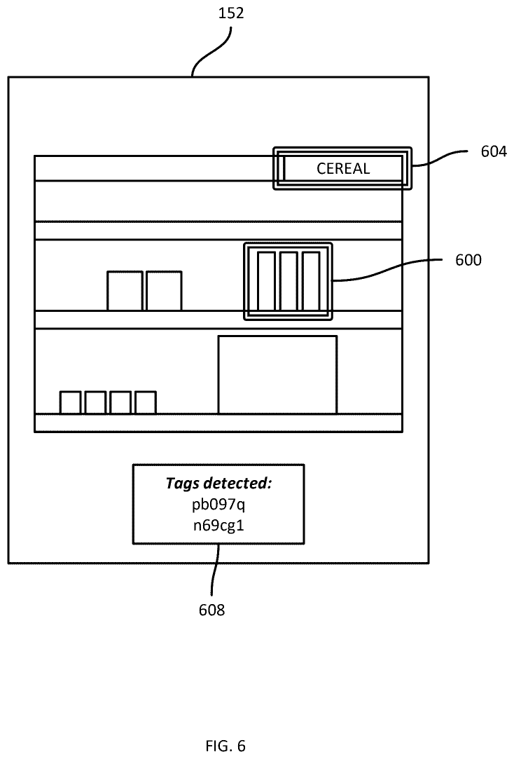

Turning to FIG. 6, an example performance of block 235 is shown, illustrating the presentation of candidate item positions determined at block 230 from the image 400. The candidate positions can be presented as overlays on the image 400, for example. In particular, the device 100 is configured to present a candidate position 600 on the display 152, corresponding to a merger of the bounding box 500-1 with bounding boxes corresponding to the two adjacent items 108 of the same type. The device 100 can also generate a candidate position 604 corresponding to the bounding box 500-2. Although the candidate position 604 does not correspond to an item 108, the position 604 may nevertheless guide the operator of the device 100 towards the relevant items 108. In other examples, the device 100 can omit candidate positions such as the position 604, e.g., because the height of the bounding box 500-2 does not match the expected height from block 210. The device 100 can also present on the display 152 the tag identifiers from block 215 that are associated with the currently sought item 108. e.g., in a list 608.

The performance of the method 200 can be repeated, e.g., when an item 108 from the pick list 300 has been picked and the operator of the device 100 begins to seek the next item on the pick list 300.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, comprising:
obtaining an item identifier;
capturing, via a camera, an image of a portion of a facility;
capturing, via a radio frequency identification (RFID) reader, a tag identifier from an RFID tag associated with an item disposed in the facility;
in response to determining that the tag identifier is associated with the item identifier, detecting from the image a visual feature of the item identifier;
determining, based on the visual feature, a candidate position of the item and the RFID tag in the image; and
controlling an output device to present the candidate position.

2. The method of claim 1, wherein the item identifier includes at least one of a stock-keeping unit (SKU) or a global trade item number (GTIN).

3. The method of claim 1, wherein determining that the tag identifier is associated with the item identifier includes:
obtaining a candidate item identifier based on the tag identifier; and
determining that the candidate item identifier matches the item identifier.

4. The method of claim 1, further comprising:
prior to detecting the visual feature, retrieving the visual feature from a repository, based on the item identifier.

5. The method of claim 1, wherein the visual feature is selected from the group consisting of:
a color of the item,
a dimension of the item,
a shape of the item,
a color of a receptacle containing the item,
a dimension of the receptacle,
a shape of the receptacle,
a text string, and
a category of the item.

6. The method of claim 1, wherein capturing the image is substantially simultaneous with capturing the tag identifier.

7. The method of claim 1, wherein controlling the output device to present the candidate position includes:
displaying the candidate position overlaid on the image.

8. The method of claim 7, further comprising:
displaying the tag identifier with the image and the candidate position.

9. A computing device, comprising:
a camera;
a radio frequency identification (RFID) reader; and
a processor configured to:
obtain an item identifier;
capture, via the camera, an image of a portion of a facility;
capture, via the radio frequency identification reader, a tag identifier from an RFID tag associated with an item disposed in the facility;
in response to determining that the tag identifier is associated with the item identifier, detect from the image a visual feature of the item identifier;
determine, based on the visual feature, a candidate position of the item and the RFID tag in the image; and
control an output device to present the candidate position.

10. The computing device of claim 9, wherein the item identifier includes at least one of a stock-keeping unit (SKU) or a global trade item number (GTIN).

11. The computing device of claim 9, wherein the processor is configured to determine that the tag identifier is associated with the item identifier by:
obtaining a candidate item identifier based on the tag identifier; and
determining that the candidate item identifier matches the item identifier.

12. The computing device of claim 9, wherein the processor is configured to:
prior to detecting the visual feature, retrieve the visual feature from a repository, based on the item identifier.

13. The computing device of claim 9, wherein the visual feature is selected from the group consisting of:
a color of the item,
a dimension of the item,
a shape of the item,
a color of a receptacle containing the item,
a dimension of the receptacle,
a shape of the receptacle,
a text string, and
a category of the item.

14. The computing device of claim 9, wherein capturing the image is substantially simultaneous with capturing the tag identifier.

15. The computing device of claim 9, wherein the processor is configured to control the output device to present the candidate position by:
displaying the candidate position overlaid on the image.

16. The computing device of claim 15, wherein the processor is configured to:
display the tag identifier with the image and the candidate position.

17. A non-transitory computer-readable medium storing a plurality of instructions executable by a processor of a computing device to:
obtain an item identifier;
capture, via a camera, an image of a portion of a facility;
capture, via a radio frequency identification (RFID) reader, a tag identifier from an RFID tag associated with an item disposed in the facility;
in response to determining that the tag identifier is associated with the item identifier, detect from the image a visual feature of the item identifier;
determine, based on the visual feature, a candidate position of the item and the RFID tag in the image; and
control an output device to present the candidate position.

18. The non-transitory computer-readable medium of claim 17, where the instructions are further executable by the processor to determine that the tag identifier is associated with the item identifier by:
obtaining a candidate item identifier based on the tag identifier; and
determining that the candidate item identifier matches the item identifier.

19. The non-transitory computer-readable medium of claim 17, wherein the visual feature is selected from the group consisting of:
a color of the item,
a dimension of the item,
a shape of the item,
a color of a receptacle containing the item,
a dimension of the receptacle,
a shape of the receptacle,
a text string, and
a category of the item.

20. The non-transitory computer-readable medium of claim 17, where the instructions are further executable by the processor to control the output device to present the candidate position by:
displaying the candidate position overlaid on the image.
